(19) United States
(12) Patent Application Publication
(10) Pub. No.: US 2006/0276612 A1
(43) Pub. Date: Dec. 7, 2006

(54) Method for producing oil-resistant elastomer and oil-resistant seal member

(75) Inventor: Hitoshi Shirasaka, Yokohama-shi (JP)

Correspondence Address: GOMEZ INTERNATIONAL PATENT OFFICE, LLC, 1501 N. RODNEY STREET, SUITE 101, WILMINGTON, DE, 19806, US

(73) Assignee: Hokushin Corporation, Yokohama-shi (JP)

(21) Appl. No.: 11/455,525

(22) Filed: Jun. 19, 2006

Related U.S. Application Data
(63) Continuation-in-part of application No. 10/759,851, filed on Jan. 16, 2004, now abandoned.
Application No. 10/759,851 is a continuation-in-part of application No. 10/011,303, filed on Dec. 5, 2001, now abandoned.

(30) Foreign Application Priority Data
Dec. 5, 2000 (JP) 2000-369701

(51) Int. Cl. C08G 18/00

(52) U.S. Cl. 528/44

(57) ABSTRACT

The invention provides a method for producing an oil-resistant elastomer being cross-linked millable polyurethane obtained by polyaddition of at least one polyester diol and at least one diisocyanate, comprising the steps of:selecting the kinds and blend proportion of the at least one polyester diol and the at least one diisocyanate, respectively, so that the resulting polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), reacting the at least one polyester diol and at least one diisocyanate to produce a millable polyurethane, and crosslinking the millable polyurethane with a curing agent to form an oil-resistant elastomer which has a rubber hardness of JIS A 95° or less and an elongation at break of at least 100%, wherein the elastomer exhibits a percent change in weight, when exposed to IRM 903 lubricating oil, of 20% or less.

### CROSS-REFERENCE TO RELATED APPLICATIONS

This is a Continuation-in-Part of U.S. application Ser. No. 10/759,851, filed Jan. 16, 2004, now pending. U.S. application Ser. No. 10/759,851, is a Continuation-in-Part of U.S. application Ser. No. 10/011,303, filed Dec. 5, 2001, now abandoned.

### BACKGROUND OF THE INVENTION

1. Field of the Invention

The present invention relates to a method for producing an oil-resistant elastomer for use in parts of industrial machinery and transport machinery such as automobiles. More particularly, the invention relates to a method for producing an oil-resistant elastomer useful for components which require oil resistance, that is an oil-resistant seal member, such as O-rings, packings, and oil-seal member (for example, an oil-seal or a rod-seal packing used on a shaft or a rod), or hoses.

2. Background Art

Generally, rubber materials such as acrylonitrile-butadiene rubber (NBR), hydrogenated acrylonitrile-butadiene rubber (HNBR), polysulfide rubber, acrylic rubber, epichlorohydrin rubber, and fluoroelastomer are employed as elastomers having oil resistance to hydrocarbon oils and fats such as gasoline and grease. The molecular structure of any of these rubber materials contains, in a main chain or a side chain, a polar group including an atom such as nitrogen, oxygen, sulfur, or halogen.

Although elastomers formed from any of these rubber materials exhibit oil resistance, most of these materials have poor elastomer properties other than oil resistance. The poor elastomer properties may be attributed to the essential feature of the aforementioned molecular structure. Briefly, by introducing a polar group such as a nitrile group, molecular movement is restricted, resulting in deterioration in rubber elasticity and low-temperature characteristics. When oxygen or sulfur is introduced in the main chain, molecular movement is maintained, but mechanical strength of the elastomer becomes poor. Thus, attaining both oil resistance and basic physical properties such as mechanical strength, low-temperature resistance, heat resistance, and rubber elasticity is very difficult.

### SUMMARY OF THE INVENTION

In view of the foregoing, the present inventors have carried out extensive studies on oil-resistant elastomer members, and have found that the aforementioned problems can be solved by use of an elastomer member formed of a poly-ester-urethane having a strictly limited composition. The present invention has been accomplished on the basis of this finding.

Thus, an object of the present invention is to provide a method for producing an oil-resistant elastomer and an elastomer member, such as an oil-resistant seal member, endowed with oil resistance as well as well-balanced physical properties; i.e., high mechanical strength with excellent low-temperature resistance, heat resistance, and rubber elasticity.

Accordingly, in the first aspect of the present invention, there may be provided a method for producing an oil-resistant elastomer comprising the following steps: selecting, as raw materials of a millable polyurethane obtainable by polyaddition of a polyester diol and a diisocyanate, the polyester diol and the diisocyanate so that the polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), wherein the polyester diol is an aliphatic polyester diol containing no side chain; subjecting the polyester diol and the diisocyanate to polyaddition reaction to thereby produce a millable polyurethane; and crosslinking the millable polyurethane with a crosslinking agent to form an oil resistant elastomer which has a JIS A rubber hardness of 95° or less and an elongation at break of at least 100%, and which is resistant to a lubricating oil which highly swells an object.

The polyester diol may consist essentially of poly(ε-caprolactone diol).

The diisocyanate may be selected from among 2,4-toluene diisocyanate (TDI), 4,4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

The diisocyanate may be 4,4′-diphenylmethane diisocyanate (MDI).

The oil resistant elastomer gives an oil resistant member having a glass transition temperature of −30° C. or lower.

The oil resistant elastomer may exhibit a percent change in mass of 20% or less, when exposed to a lubricating oil which highly swells an object.

In the second aspect of the present invention, there may be provided an oil-seal member which is formed by an oil-resistant elastomer; wherein the oil-resistant elastomer has a rubber hardness of JIS A 95° or less and an elongation at break of at least 100%, the elastomer being cross-linked millable polyurethane obtained by polyaddition of at least one polyester diol and at least one diisocyanate, wherein the polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), wherein the elastomer exhibits a percent change in weight, when exposed to IRM 903 lubricating oil, of 20% or less.

The polyester diol may consist essentially of poly(ε-caprolactone diol).

The diisocyanate may be selected from among 2,4-toluene diisocyanate (TDI), 4,4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

The diisocyanate may be 4,4′-diphenylmethane diisocyanate (MDI).

The oil-seal member may have a glass transition temperature of −30° C. or lower.

Various other objects, features, and many of the attendant advantages of the present invention will be readily appreciated as the same becomes better understood with reference to the following detailed description of the preferred embodiments when considered in connection with the accompanying drawing and tables.

### BRIEF DESCRIPTION OF THE DRAWINGS

FIG. 1 shows an example of an oil-seal member of the present invention.

### DETAILED DESCRIPTION OF PREFERRED EMBODIMENTS

In the present invention, the polyester composition of an elastomer formed through cross-linking of a polyurethane obtained through polyaddition of polyester diol and diisocyanate is limited, so that the resulting polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), to thereby provide an elastomer endowed with oil resistance as well as well-balanced physical properties; i.e., high mechanical strength with excellent low-temperature resistance, heat resistance, and rubber elasticity.

Here, it should be noted that if the ester group concentration is lower than the relevant defined range, excellent oil resistance cannot be obtained, whereas if the ester group concentration is higher than the range, mechanical strength lowers, although oil resistance is high. Thus, intended products cannot be obtained. Similarly, if the urethane group concentration is lower than the relevant defined range, poor oil resistance results, whereas if the urethane group concentration is higher than the defined range, oil resistance is enhanced with certain disadvantages; i.e., temperature dependence of rubber elasticity increases, in particular, rubber elasticity at low temperature becomes poor.

The ester group concentration and the urethane group concentration are calculated on the basis of the molecular structure, and may be expressed by the following equations.
Ester group concentration (mmol/g)=(number of moles of ester group)/(weight of polyester polyol)
Urethane group concentration (mmol/g)=(number of moles of urethane group)/(weight of polyurethane)

Examples of the polyester diol to be used in the present invention include poly(ε-caprolactone diol) which is formed through an addition reaction of ε-caprolactone and a C2-C9 linear glycol serving as a starting diol such as ethylene glycol or 1,4-butylene glycol, and aliphatic polyester diols which are formed through polycondensation of a C2-C9 linear glycol and a C2-C8 linear dibasic acid.

Examples of the diisocyanate to be caused to react with polyester diol include 2,4-toluene diisocyanate (TDI), 4 4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

Examples of particularly preferred polyurethanes for constituting the elastomer member of the present invention include a polyurethane formed from poly(ε-caprolactone diol) and MDI.

In the present invention, the above-described polyester diol, which is a long chain polyol, is used as a main component of the polyol and in addition thereto chain extenders generally used can be employed in amounts within the range where the object of the present invention is not harmed. Examples of the chain extenders include straight chain glycols having 2 to 12 carbon atoms in the main chain, such as ethylene glycol, thiodiethanol, propylene glycol, and butylene glycol; diols having an aromatic ring and having up to 12 carbon atoms, such as 1,4-bis(hydroxyethoxy)benzene and p-xylene glycol and hydrogenated products thereof. Additionally, triols such as trimethylol; or stearyl alcohol, hydroxyethyl acrylate, and the like can also be used.

In the case where the polyurethane obtained by the method of the present invention is crosslinked with sulfur, a compound having an unsaturated bond is used as a part of the polymerization initiator or chain extender in accordance with conventional manner.

In the method of the present invention, an oil-resistant elastomer being cross-linked millable polyurethane obtained by polyaddition of at least one polyester diol and at least one diisocyanate is obtained by the steps of: selecting the kinds of the at least one polyester diol and at least one diisocyanate and blend of the at least one polyester diol to the at least one diisocyanate, respectively, thereby the resulting polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), reacting the at least one polyester diol and at least one diisocyanate to produce a millable polyurethane, and crosslinking the millable polyurethane with a curing agent to form an oil-resistant elastomer which has a rubber hardness of JIS A 95° or less and an elongation at break of at least 100%, wherein the elastomer exhibits a percent change in weight, when exposed to IRM 903 lubricating oil, of 20% or less.

Here, the at least one polyester diol and at least one diisocyanate are selected in the above-mentioned examples, respectively. Blend proportion of polyester diol and at least one diisocyanate may be within generally used ranges, on the condition that the resulting polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g). For example, active hydrogen such as hydroxyl group in the diol and isocyanate are blended in equimolar amounts. More specifically, for example, 25 producing by weight of MDI per 100 parts by weight of the diol is used for a hydroxyl number (OHv: KOHmg/g) of 112, 20.8 parts by weight of MDI per 100 parts by weight of diol for OHv of 94, 16.7 parts by weight of MDI per 100 parts by weight of diol for OHv of 75.

Next, the millable polyurethane of the present invention is kneaded with a curing agent and heat cured (crosslinked). Examples of such a curing agent include organic peroxides, sulfur, organic sulfur-containing compounds, isocyanates, and the like for ordinary synthetic rubbers. In the method of the present invention, generally, organic peroxides are used. Examples of the organic peroxides include dicumyl peroxide, a,a′-bis(t-butylperoxyisopropyl)benzene, and the like. The amount of the organic peroxide to be added is on the level of 0.5 to 10 parts by weight, preferably 1.5 to 5 parts by weight, per 100 parts by weight of combined polyester diol and isocyanate. It is in the case where the polymerization initiator or chain extender has an unsaturated bond, such as 3-allyl- 1,2-propanediol, that sulfur and organic sulfur containing compounds can be used as a curing agent. Examples of the organic sulfur-containing compounds include zinc chloride complex of 2-mercaptobenzo thiazole, and the like.

Upon kneading and curing as described above, commonly used additives, i.e., reinforcing materials such as carbon black, silica, etc., detackifiers such as wax, plasticizers such as tributyl trimellitate (TBTM), tetrabutyl pyromellitate (TBPM), dibutyl phthalate (DBP) can be used. Here, in the present invention, general plasticizers such as dioctyl phthalate (DOP) is not desirable because a low-polarity plasticizer isn't desirable.

The polyurethane of the present invention may contain a hydrolysis preventing agent such as polycarbodiimide in amounts of about 0.2 to 3 producing by weight per 100 parts by weight of the polyurethane in the same manner as in conventional methods. The polyurethane member of the present invention has an improved hydrolysis resistance twice or more as high as the conventional thermosetting millable polyurethanes and use of hydrolysis preventing agents in the polyurethane of the present invention in the same amount as the conventional polyurethanes the hydrolysis resistance of the polyurethane material of the present invention is increased accordingly while in order to obtain the same level of hydrolysis resistance as the conventional polyurethane materials, the amount of the additive to be added can be reduced by about 20% to 50% of the amount of the conventional additive. This contributes much to reduction in costs since the hydrolysis preventing agents are generally expensive.

The millable polyurethane of the present invention can be reacted under the conditions of generally 70° C. to 150° C. for 30 to 10 hours and thereafter aged if necessary at 40° C. to 1 20° C. for about 6 to 48 hours. The heat curing conditions of the millable polyurethane may be determined depending on the decomposition properties of the organic peroxide to be used but generally it is preferred that the heat curing conditions are set within the range of 150 to 180° C. for 3 to 60 minutes.

The oil-seal member of the present invention is formed by the method of the present invention, that is, crosslinking the above millable polyurethane with a curing agent and molding the resulting cured polyurethane to form an oil-seal member, such as 0-rings and packings.

### EXAMPLES

The present invention will next be described in detail by way of examples, which should not be construed as limiting the invention thereto. The oil-resistant rubber according to the present invention has been compared with NBR, HNBR, and millable poly-ester-urethane, which are generally employed as oil-resistant rubber.

### Example 1

ε-Caprolactone and 1,4-butylene glycol serving as a starting diol were subjected to an addition reaction, to thereby yield a polyester diol having a hydroxyl value of 110. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 28% and a urethane group concentration of 9.3%.

Dicumyl peroxide (Percumyl D, product of Nippon Oil & Fats Co., Ltd.) (2 parts by weight) was added to the obtained polyurethane rubber (100 parts by weight), and the resultant mixture was press-formed at 160° C. for 20 minutes, to thereby yield an elastomer.

### Comparative Example 1

The procedure in Example 1was repeated, except that commercially available HNBR (constituent acrylonitrile amount: 36%, iodine value: 28 g/100 g) (Zetpol 1020, product of Nippon Zeon Co., Ltd.) was used, to thereby yield an elastomer.

### Comparative Example 2

The procedure in Example 1 was repeated, except that commercially available NBR (constituent acrylonitrile amount: 50%) (Nipol DN003, product of Nippon Zeon Co., Ltd.) was used, to thereby yield an elastomer.

### Comparative Example 3

The procedure in Example 1 was repeated, except that commercially available NBR (constituent acrylonitrile amount: 35%) (N230S, product of Japan Synthetic Rubber Co., Ltd.) was used, to thereby yield an elastomer.

### Comparative Example 4

The procedure in Example 1 was repeated, except that commercially available NBR (constituent acrylonitrile amount: 18%) (Nipol DN401L, product of Nippon Zeon Co., Ltd.) was used, to thereby yield an elastomer.

### Test Example 1

Each of elastomer samples obtained in Example 1 and Comparative Examples 1 to 4 was evaluated in terms of general physical properties. Table 1 shows the results. Hardness (JIS A) was measured in accordance with JIS K6253 (corresponding to ASTM D2240). Rebound resilience (%) was measured in accordance with JIS K6255 (corresponding to ISO 4462). Compressive permanent strain (%) was measured in accordance with JIS K6262(corresponding to ISO 815 and ISO/DIS 2285). Tensile strength (MPa) was measured in accordance with JIS K6251 (corresponding to ISO 37). Elongation at break (%) was measured in accordance with JIS K6251 (corresponding to ISO 37).

TABLE 1

| | | Comp. | Comp. | Comp. | Comp. |
|---|---|---|---|---|---|
| | Ex. 1 | Ex. 1 | Ex. 2 | Ex. 3 | Ex. 4 |
| Amount of constituent | — | 36 | 50 | 35 | 18 |
| acrylonitrile (%) | | | | | |
| Hardness (JIS A) | 54 | 50 | 52 | 53 | 58 |
| Rebound resilience (%) | 73 | 69 | 10 | 57 | 80 |
| Compressive | 8 | 17 | 7 | 2 | breakage |
| permanent strain (%) | | | | | |
| Tensile strength (MPa) | 12.3 | 8.4 | 7.2 | 2.8 | 1.1 |
| Elongation at break (%) | 600 | 630 | 490 | 190 | 20 |
| Glass transition | −38 | −29 | −4 | −26 | −46 |
| temp. (° C.) | | | | | |

As shown in Table 1, the sample in Example 1 shows remarkably high mechanical strength. NBR samples in Comparative Examples 1 to 4 exhibit upward shift of glass transition temperature with increasing nitrile content, leading to deterioration of low-temperature resistance. The glass transition temperature of the sample in Example 1 is lower than that of the samples in Comparative Examples 1 to 3 having an intermediate to high nitrile content, and nearly equal to that of the sample in Comparative Example 4 having a low nitrile content. The sample in Example 1 shows high rebound resilience, which is an index of rubber elasticity. Similar to the case of glass transition temperature, rebound resilience of NBR samples in the Comparative Examples is observed to depend on the nitrile content.

### Test Example 2

Each of elastomer samples obtained in Example 1 and Comparative Examples 1 to 4 was evaluated in terms of oil resistance. Table 2 shows the results. Oil resistance to lubricating oil was evaluated on the basis of physical properties after completion of immersion of each sample in ASTM No.3 oil at 100° C. for 72 hours. Oil resistance to fiel oil was evaluated on the basis of physical properties after completion of immersion of each sample in FUEL C (isooctane/toluene =50/50 vol.%) at 40° C. for 72 hours. Hardness (JIS A), tensile strength, and elongation at break were measured in a manner similar to that employed in Test Example 1, and the percent increase in weight (%) was measured in accordance with JIS K6258 (corresponding to ISO 1817).

TABLE 2

| | | | Comp. | Comp. | Comp. | Comp. |
|---|---|---|---|---|---|---|
| | | Ex. 1 | Ex. 1 | Ex. 2 | Ex. 3 | Ex. 4 |
| Lubricating | Hardness | 46 | 40 | 54 | 53 | 57 |
| oil | (JIS A) | | | | | |
| | Tensile strength (MPa) | 13.4 | 3.3 | 3.4 | 1.7 | breakage |
| | Elongation at break (%) | 460 | 370 | 260 | 100 | breakage |
| | Percent increase in | 6.9 | 21.4 | 1.2 | 18.9 | 49 |
| | weight (%) | | | | | |
| Fuel | Hardness | 44 | 33 | 40 | 50 | 45 |
| oil | (JIS A) | | | | | |
| | Tensile strength (MPa) | 8.2 | 3.3 | 2.4 | breakage | breakage |
| | Elongation at break (%) | 410 | 440 | 260 | breakage | breakage |
| | Percent increase in | 32.9 | 64.7 | 31.2 | 55.5 | 100 |
| | weight (%) | | | | | |

As shown in Table 2, in terms of oil resistance to either lubricating oil (ASTM No. 3 oil) or fuel oil (FUEL C), the sample in Example 1 is much superior to the samples in Comparative Examples 1 and 3 having an intermediate to high nitrile content. The oil resistance of the sample in Example 1 is approximately equivalent to that of the sample in Comparative Example 2 having a very high nitrile content.

The swelling ratio of NBR samples of Comparative Examples 1 to 4 decreases as the nitrile content increases. However, the glass transition temperature serving as an index of low-temperature resistance is elevated, failing to attain both low-temperature resistance and oil resistance. In contrast, the sample in Example 1 shows excellent oil resistance while the glass transition temperature thereof remains low.

### Example 2

To the polyurethane rubber (100 parts by weight) which had been obtained in Example 1, carbon black (Seast SO, product of Tokai Carbon Co., Ltd.) (20 parts by weight), an age resister (Stabaxol P, product of Sumitomo Bayer Urethane Co., Ltd) (1.5 parts by weight), and a cross-linking agent (Percumyl D, product of Nippon Oil & Fats Co., Ltd.) (2 parts by weight) were added, and the resultant mixture was press-formed at 1 60° C. for 20 minutes, to thereby yield an elastomer sample.

### Comparative Examples 5 to 8

In a manner similar to that of Example 2, except that an age resister (Antage RD, product of Kawaguchi Chemical Industry Co., Ltd.) (1.5 parts by weight) was used, the above additives were added at the same compositional proportions to each of the polymers of Comparative Examples 1 to 4, to thereby yield a compound. A cross-linked elastomer was prepared from the compound.

### Test Example 3

Each of the elastomer samples obtained in Example 2 and Comparative Examples 5 to 8 was evaluated in terms of general physical properties. Table 3 shows the results. Hardness (JIS A), rebound resilience, compressive permanent strain, tensile strength, and elongation at break were measured in a similar manner to that employed in Test Example 1.

TABLE 3

| | | Comp. | Comp. | Comp. | Comp. |
|---|---|---|---|---|---|
| | Ex. 2 | Ex. 5 | Ex. 6 | Ex. 7 | Ex. 8 |
| Hardness (JIS A) | 64 | 58 | 63 | 60 | 62 |
| Rebound resilience (%) | 71 | 63 | 8 | 49 | 73 |
| Compressive | 13 | 14 | 15 | 3 | 2 |
| permanent strain (%) | | | | | |
| Tensile strength (MPa) | 29.1 | 25.2 | 20.3 | 10.6 | 4.5 |
| Elongation at break (%) | 490 | 800 | 600 | 250 | 150 |

As shown in Table 3, remarkable reinforce effect provided by carbon black is observed for NBR elastomers in Comparative Examples 5 to 8, but the tensile strength thereof is inferior to that of the NBR elastomer in Example 2.

### Test Example 4

Each of elastomer samples obtained in Example 2 and Comparative Examples 5 to 8 was evaluated in terms of heat-aging resistance (at 150° C.). Table 4 shows the physical properties measured after aging tests (after maintenance at 150° C. for 72 hours and at 150° C. for 168 hours). Hardness (JIS A), tensile strength, and elongation at break were measured in a similar manner to that employed in Test Example 1.

TABLE 4

| | | | Comp. | Comp. | Comp. | Comp. |
|---|---|---|---|---|---|---|
| | | Ex. 2 | Ex. 5 | Ex. 6 | Ex. 7 | Ex. 8 |
| 150° C. | Hardness (JIS A) | 63 | 62 | 96 | 81 | 85 |
| 72 hr | Tensile strength | 26.4 | 23.7 | 12.1 | 6.9 | 2.4 |
| | (MPa) | | | | | |
| | Elongation | 440 | 510 | 80 | 70 | 10 |
| | at break (%) | | | | | |
| 150° C. | Hardness (JIS A) | 60 | 65 | 99 | 99 | 97 |
| 168 hr | Tensile strength | 18.2 | 14.7 | 16 | 7.3 | 4.3 |
| | (MPa) | | | | | |
| | Elongation | 360 | 280 | 10 | 4 | 1 |
| | at break (%) | | | | | |

As shown in Table 4, NBR elastomers in Comparative Examples 5 to 8 exhibit a great amount of change in physical property, particularly hardness. Among these elastomers, HNBR in Comparative Example 5, prepared by hydrogenating remaining double bonds provided from butadiene, exhibits comparatively favorable maintenance in physical property. However, the elastomer sample in Example 2 has been found to exhibit superior maintenance in physical property.

### Example 3

Adipic acid and 1,4-butanediol linear glycol were subjected to polycondensation, to thereby yield a polyester diol having a hydroxyl value of 112. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 32.0% and a urethane group concentration of 9.4%.

The urethane rubber and additives were mixed at the same compositional proportions as those employed in Example 1, to thereby yield a compound. A cross-linked elastomer was prepared from the compound.

### Example 4

Adipic acid and 1,4-butanediol/1,6-hexanediol (50/50 mol %) linear glycol were subjected to polycondensation, to thereby yield a polyester diol having a hydroxyl value of 96. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 31% and a urethane group concentration of 8.3%.

The urethane rubber and additives were mixed at the same compositional proportions as those employed in Example 1, to thereby yield a compound. A cross-linked elastomer was prepared from the compound.

### Comparative Example 9

Adipic acid and ethylene glycol/1,4-butanediol (50/50 mol %) linear glycol were subjected to polycondensation, to thereby yield a polyester diol having a hydroxyl value of 56. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 40.5% and a urethane group concentration of 5.2%.

The urethane rubber and additives were mixed at the same compositional proportions as those employed in Example 1, to thereby yield a compound. A cross-linked elastomer was prepared from the compound.

### Comparative Example 10

Adipic acid and 3-methyl-1,5-pentanediol glycol having a side-chain methyl group were subjected to polycondensation, to thereby yield a polyester diol having a hydroxyl value of 28. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 35% and a urethane group concentration of 2.8%.

The urethane rubber and additives were mixed at the same compositional proportions as those employed in Example 1, to thereby yield a compound. A cross-linked elastomer was prepared from the compound.

### Comparative Example 11

ε-Caprolactone and ethylene glycol serving as a starting diol were subjected to an addition reaction, to thereby yield a polyester diol having a hydroxyl value of 155. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 26% (6.0 mmol/g) and a urethane group concentration of 12.1% (2.1 mmol/g).

The urethane rubber and additives were mixed at the same compositional proportions as those employed in Example 1, to thereby yield a compound. A cross-linked elastomer was prepared from the compound.

### Comparative Example 12

Adipic acid and 1,6-hexanediol/neopentyl glycol(70/30 mol %) mixture of linear glycol and glycol having a side-chain group were subjected to polycondensation, to thereby yield a polyester diol having a hydroxyl value of 54. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 27.0% and a urethane group concentration of 4.5%.

The urethane rubber and additives were mixed at the same compositional proportions as those employed in Example 1, to thereby yield a compound. A cross-linked elastomer was prepared from the compound.

### Comparative Example 13

Commercially available millable poly-ester-urethane (trade name, Urepan 640G) was used as a urethane rubber.

The urethane rubber and additives were mixed at the same compositional proportions as those employed in Example 1, to thereby yield a compound. A cross-linked elastomer was prepared from the compound.

### Comparative Example 14

Commercially available millable poly-ester-urethane (trade name, Urepan 641 G) was used as a urethane rubber.

The urethane rubber and additives were mixed at the same compositional proportions as those employed in Example 1, to thereby yield a compound. A cross-linked elastomer was prepared from the compound.

### Test Example 5

Each of millable poly-ester-urethane elastomer samples obtained in Examples 1, 3 and 4, and Comparative Examples 9 to 14 was evaluated in terms of general physical properties as the hydrolysis resistance; percent changes in hardness (AHs) and weight (AM) after immersion in IRM 903 oil (lubricating oil which highly swells an object, listed in ISO/DIS 1817) at 100° C. for 72 hours; and change in hardness (AHs) after the sample had been allowed to stand for 14 days at 85° C. and 95% RH. Table 5 shows the results. Hardness Hs (JIS A) was measured in accordance with JIS K6253. Rebound resilience Rb (%) was measured in accordance with JIS K6255. Tensile strength Tb (MPa) and elongation at break Eb (%) were measured in accordance with JIS K625 1.

TABLE 5

| | | | | Comp. | Comp. | Comp. | Comp. | Comp. | Comp. |
|---|---|---|---|---|---|---|---|---|---|
| | Ex. 1 | Ex. 3 | Ex. 4 | Ex. 9 | Ex. 10 | Ex. 11 | Ex. 12 | Ex. 13 | Ex. 14 |
| Ester group | 28 | 32 | 31 | 41 | 35 | 26 | 27 | — | — |
| concentration | | | | | | | | | |
| wt. % | | | | | | | | | |
| Ester group | 6.4 | 7.3 | 7.0 | 9.2 | 8.0 | 6.0 | 6.1 | — | — |
| concentration | | | | | | | | | |
| mmol % | | | | | | | | | |
| Urethane | 9.3 | 9.4 | 8.3 | 5.2 | 2.8 | 12.1 | 5.1 | — | — |
| group | | | | | | | | | |
| concentration | | | | | | | | | |
| wt. % | | | | | | | | | |
| Urethane | 1.6 | 1.6 | 1.4 | 0.9 | 0.5 | 2.1 | 0.9 | — | — |
| group | | | | | | | | | |
| concentration | | | | | | | | | |
| mmol % | | | | | | | | | |
| Hardness (JIS | 54 | 55 | 53 | 55 | 48 | 58 | 54 | 56 | 55 |
| A) | | | | | | | | | |
| Rebound | 73 | 70 | 77 | 65 | 78 | 67 | 66 | 68 | 65 |
| resilience (%) | | | | | | | | | |
| Tensile | 12.3 | 15.5 | 10.8 | 8.6 | 2.7 | 16.7 | 8.4 | 10.8 | 6.5 |
| strength (MPa) | | | | | | | | | |
| Elongation at | 600 | 680 | 660 | 560 | 280 | 570 | 520 | 620 | 440 |
| break (%) | | | | | | | | | |
| Tg (° C.) | −38 | −36 | −40 | −42 | −54 | −26 | −44 | −42 | −35 |
| Oil resistance | −3 | −3 | −4 | −9 | −5 | −1 | −5 | −5 | −4 |
| ΔHs | | | | | | | | | |
| Oil resistance | 3.6 | 3.6 | 7.8 | 3.8 | 16.2 | 2.2 | 9.8 | 3.2 | 8.4 |
| ΔM | | | | | | | | | |
| Hydrolysis | −4 | −6 | −6 | −34 | −3 | −4 | −5 | −28 | −4 |
| resistance ΔHs | | | | | | | | | |

Table 5 provides comparison in physical properties of millable urethane elastomers having a variety of compositions. As shown in Table 5, the elastomer sample in Comparative Example 9 has considerably poor hydrolysis resistance conceivably due to an ester group concentration higher than the upper limit of the concentration range. The elastomer sample in Comparative Example 10 has poor mechanical strength, conceivably due to constituent polyester having a large amount of side-chain methyl groups. The elastomer sample in Comparative Example 11 has a high glass transition temperature (Tg) and poor low-temperature characteristics, conceivably due to a urethane group concentration higher than the upper limit of the concentration range. The sample of Comparative Example 12, which is formed from a polyester having a small amount of side-chain groups, exhibits poor mechanical strength and has a poor oil resistance as compared with the samples of Examples 3 and 4.

In contrast, elastomers in Examples 2 to 4, which are formed from a polyurethane having an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), are found to be endowed with oil resistance and hydrolysis resistance as well as well-balanced physical properties; i.e., high mechanical strength with excellent low-temperature resistance and rubber elasticity.

### Example 5

ε-Caprolactone and 1,4-butylene glycol serving as a starting diol were subjected to an addition reaction, to thereby yield a polyester diol having a hydroxyl value of 110. The polyester diol and MDI were subjected to polyaddition such that the amount of hydroxyl groups and that of isocyanate are adjusted to be equimol, to thereby yield a polyurethane rubber. The thus-formed polyurethane rubber had an ester group concentration of 28% and a urethane group concentration of 9.3%.

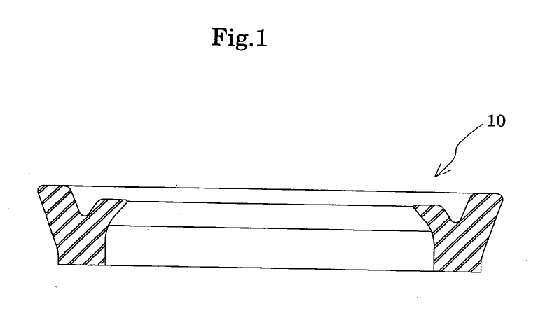

Dicumyl peroxide (Percumyl D, product of Nippon Oil & Fats Co., Ltd.) (2 parts by weight) was added to the obtained polyurethane rubber (100 parts by weight), and the resultant mixture was press-formed at 160° C. for 20 minutes, to thereby yield an O-ring having a cross-sectional shape as illustrated in FIG. 1.

### Example 6

To the polyurethane rubber (100 parts by weight) which had been obtained in Example 1, carbon black (Seast SO, product of Tokai Carbon Co., Ltd.) (20 parts by weight), an age resister (Stabaxol P, product of Sumitomo Bayer Urethane Co., Ltd) (1.5 parts by weight), and a cross-linking agent (Percumyl D, product of Nippon Oil & Fats Co., Ltd.) (2 parts by weight) were added, and the resultant mixture was press-formed at 160° C. for 20 minutes, to thereby yield a rod-seal packing as illustrated in FIG. 1. The rod-seal packing 10, which has an outside diameter of 18 mm, an inside diameter 8 mm and a height of 8mm, can be used for oil-sealing in an oil pump in such a manner that it is pressed between a housing.

As described herein above, according to the present invention, excellent oil resistance as well as well-balanced physical properties such as high mechanical strength and high rubber elasticity can be attained while low-temperature resistance is maintained, these two properties having been difficult to be attained by nitrile rubber or hydrogenated nitrile rubber. Thus, an elastomer member, such as an oil-seal member, having excellent oil resistance as well as well-balanced physical properties, which are required for elastomers, can be provided.

What is claimed is:

1. A method for producing an oil-resistant elastomer comprising the steps of:
selecting, as raw materials of a millable polyurethane obtainable by polyaddition of a polyester diol and a diisocyanate, the polyester diol and the diisocyanate so that the polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), wherein the polyester diol is an aliphatic polyester diol containing no side chain;
subjecting the polyester diol and the diisocyanate to polyaddition reaction to thereby produce a millable polyurethane; and
crosslinking the millable polyurethane with a crosslinking agent to form an oil resistant elastomer which has a JIS A rubber hardness of 95° or less and an elongation at break of at least 100%, and is resistant to a lubricating oil which highly swells an object.

2. The method for producing an oil resistant elastomer as recited in claim 1, wherein the polyester diol is poly(ε-caprolactone diol).

3. The method for producing an oil resistant elastomer as recited in claim 1, wherein the diisocyanate is selected from among 2,4-toluene diisocyanate (TDI), 4,4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

4. The method for producing an oil resistant elastomer as recited in claim 1, wherein the diisocyanate is 4,4′-diphenylmethane diisocyanate (MDI).

5. The method for producing an oil resistant elastomer as recited in claim 1, wherein the elastomer gives an oil resistant member having a glass transition temperature of −30° C. or lower.

6. The method for producing an oil resistant elastomer as recited in claim 1, wherein the oil resistant elastomer, when exposed to a lubricating oil which highly swells an object, exhibits a percent change in mass of 20% or less.

7. An oil-seal member which is formed by an oil-resistant elastomer; wherein the oil-resistant elastomer has a rubber hardness of JIS A 95° or less and an elongation at break of at least 100%, the elastomer being cross-linked millable polyurethane obtained by polyaddition of at least one polyester diol comprising aliphatic polyester diol containing no side chain and at least one diisocyanate, wherein the polyurethane has an ester group concentration of at least 25 wt. % (5.7 mmol/g) and less than 35 wt. % (8 mmol/g) and a urethane group concentration of at least 7 wt. % (1.2 mmol/g) and less than 12 wt. % (2.0 mmol/g), wherein the elastomer exhibits a percent change in weight, when exposed to IRM 903 lubricating oil, of 20% or less.

8. The oil-seal member of claim 7, wherein the polyester diol comprises poly(ε-caprolactone diol).

9. The oil-seal member as recited in claim 7, wherein the diisocyanate is selected from among 2,4-toluene diisocyanate (TDI), 4,4′-diphenylmethane diisocyanate (MDI), p-phenylene diisocyanate (PPDI), 1,5-naphthalene diisocyanate (NDI), and 3,3-dimethyldiphenyl-4,4′-diisocyanate (tolidine diisocyanate) (TODI).

10. The oil-seal member as recited in claim 7, wherein the diisocyanate is 4,4′-diphenylmethane diisocyanate (MDI).
